(19) United States
(12) Patent Application Publication
(10) Pub. No.: US 2011/0121184 A1
(43) Pub. Date: May 26, 2011

(54) DOI RADIATION DETECTOR

(75) Inventors: Naoko Inadama, Chiba (JP); Hideo Murayama, Chiba (JP); Kengo Shibuya, Chiba (JP); Fumihiko Nishikido, Chiba (JP); Tomoaki Tsuda, Kyoto (JP)

(73) Assignees: NATIONAL INSTITUTE OF RADIOLOGICAL SCIENCES, Chiba-shi, Chiba (JP); SHIMADZU CORPORATION, Kyoto-shi, Kyoto (JP)

(21) Appl. No.: 13/054,329

(22) PCT Filed: Jul. 16, 2008
(86) PCT No.: PCT/JP2008/062804

§ 371 Date: Jan. 18, 2011

(51) Int. Cl. G01T 1/20

(52) U.S. Cl. 250/361 R

(57) ABSTRACT

In a DOI radiation detector, scintillation crystals are arranged in three dimensions on a light receiving surface of a light receiving element, and a response of a crystal having detected a radiation ray can be identified on the light receiving surface. Thereby, a position at which the radiation ray is detected is determined in three dimensions. In this DOI radiation detector, regular triangular prism scintillation crystals are used, and response positions of the respective crystals are shifted for each set. This allows crystal identification without loss even with a structure such as a three-layer or six-layer structure hard to achieve by a quadrangular prism scintillation crystal.

### TECHNICAL FIELD

The present invention relates to a DOI radiation detector, and more specifically, relates to a DOI radiation detector which can realize crystal identification without loss even with a structure such as a three-layer or six-layer structure that is hard to achieve by a quadrangular prism scintillator crystal, and which is preferably used for positron imaging devices, positron emission tomography (PET) devices and the like in the fields of nuclear medicine imaging and radiation measurement.

### BACKGROUND ART

A generally employed radiation detector is made by optical coupling between a scintillation crystal and a light receiving element. Meanwhile, in order to provide higher spatial resolution in positron imaging devices or PET devices, a DOI (depth of interaction) radiation detector (hereinafter also called DOI detector simply) capable of detecting a position of entry in a depth direction into a detecting element has been developed. More specifically, a crystal block 20 with crystal elements arranged in three dimensions is placed on a light receiving element 10 such as a position-sensitive photomultiplier tube (PS-PMT), and a crystal element having detected a radiation ray is specified, thereby determining a detection position in three dimensions.

The DOI detector is advantageously used to specify a direction in three dimensions in which a radiation source exists. If used as a radiation detector for a PET device, the DOI detector enhances the sensitivity of the PET device without degrading resolution.

There are various techniques of specifying a crystal element in the DOI detector. As an example, a two-dimensional crystal element parallel to a light receiving surface of the light receiving element 10 is specified by Anger calculation of the output of the light receiving element. As exemplified in FIG. 2, a response of each crystal element appears on a two-dimensional (2D) position histogram showing the results of Anger calculation.

The following techniques have been proposed to identify a crystal in the depth direction, namely to identify a plurality of (in FIG. 1, three) stacked layers including two-dimensional arrays 21, 22 and 23 of crystal elements exemplified in FIG. 1.

(1) As shown in FIGS. 1(a) and 1(b), scintillators of different waveforms (LSO, GSO, and EGO in FIG. 1(a), and GSO of 1.5 mol % Ce, 0.5 mol % Ce, and 0.2 mol % Ce in FIG. 1(b)) for respective layers are used, and the layers are identified by waveform discrimination (see Patent Document 1, and Non-Patent Documents 1 and 2).

(2) A reflective material is generally inserted between crystal elements in a two-dimensional array of a scintillation crystal. In this case, a response of each crystal element appears at a position on a 2D position histogram that reflects the location of the crystal element. By using this feature, an array of 6×6 crystals, and an array of 7×7 crystals are prepared, for example, as the first and second layers 21 and 22, respectively. Then, the overlaid layers are caused to go out of alignment as shown in FIG. 3(a). Or, grooves are cut from top and bottom of the crystal block 20 to form slits 30 in each of the crystal arrays 21 and 22 as shown in FIG. 3(b) to cause the crystal elements to go out of alignment in the vertical direction. As a result, respective responses of the crystal elements in three dimensions are separated to realize identification as exemplified in FIG. 2 (see Non-Patent Documents 3 and 4).

(3) Part of a reflective material 32 in each of two-dimensional crystal arrays 21 to 24 is removed as exemplified in FIG. 4 to control spread of scintillation light, so that a position at which a response of each crystal element 30 appears is controlled. In the drawing, 34 shows air where the reflective material 31 does not exist. Thus, respective responses of all crystals arranged in three dimensions are separated and then made identifiable (see Patent Documents 2 to 5, and Non-Patent Document 5).

(4) A filter for cutting off a wavelength of a specific wavelength is interposed between layers, and a resultant wavelength is used for layer identification (see Patent Document 6, and Non-Patent Document 6).

The above-mentioned DOI detectors are each formed into a quadrangular prism crystal, or one element of each of the DOI detectors is formed into a quadrangular prism.

A technique using a triangular prism scintillation crystal as in the present invention has been proposed in a radiation detector with a two-dimensional crystal array that does not conduct DOI detection. In either case, the shape of crystals is devised to densely place scintillators. In the technique disclosed in Patent Document 7, a detector as a whole including a scintillator and a light receiving element is formed into a triangular prism. This technique allows close arrangement of a large number of detectors when the detectors are to be arranged in a sphere.

In the technique disclosed in Non-Patent Document 7,various scintillators of different types are placed on a columnar light receiving element with one acute angle of a triangle pointing to the center. A detected crystal is specified with a waveform.

In the technique disclosed in Patent Document 8, in order to place quadrangular prism detectors to form a hexagonal detection ring for PET, triangular prism scintillators and light receiving elements are used as auxiliary detectors to fill spaces.

[Patent Document 1] Japanese Patent Application Laid-Open No. Hei. 6-337289

[Patent Document 2] Japanese Patent Application Laid-Open No. Hei. 11-142523

[Patent Document 3] Japanese Patent Application Laid-Open No. 2004-132930

[Patent Document 4] Japanese Patent Application Laid-Open No. 2004-279057

[Patent Document 5] Japanese Patent Application Laid-Open No. 2007-93376

[Patent Document 6] Japanese Patent Application Laid-Open No. 2005-43062

[Patent Document 7] Japanese Patent Application Laid-Open No. Hei. 8-5746

[Patent Document 8] Japanese Patent Application Laid-Open No. Hei. 5-126957

[Non-patent Document 1] J. Seidel, J. J. Vaquero, S. Siegel, W. R. Gandler, and M. V. Green, “Depth identification accuracy of a three layer phoswich PET detector module,” IEEE Trans. on Nucl. Sci., vol.46, No. 3, pp. 485-490, June 1999

[Non-patent Document 2] S. Yamamoto and H. Ishibashi, “A GSO depth of interaction detector for PET,”IEEE Trans. on Nucl. Sci., vol. 45, No. 3, pp. 1078-1082, June 1998

[Non-patent Document 3] H. Liu, T. Omura, M. Watanabe, and T. Yamashita, “Development of a depth of interaction detector for y-rays,” Nucl. Inst. Meth., A459, pp. 182-190, 2001.

[Non-patent Document 4] N. Zhang, C. J. Thompson, D. Togane, F. Cayouette, K. Q. Nguyen, M. L. Camborde, “Anode position and last dynode timing circuits for dual-layer BGO scintillator with PS-PMT based modular PET detectors,” IEEE Trans. Nucl. Sci., Vol. 49, No. 5, pp. 2203-2207, October 2002.

[Non-patent Document 5] T. Tsuda, H. Murayama, K. Kitamura, T. Yamaya, E. Yoshida, T. Omura, H. Kawai, N. Inadama, and N. Orita, “A four-layer depth of interaction detector block for small animal PET,” IEEE Trans. Nucl. Sci., vol. 51, pp. 2537-2542, October 2004.

[Non-patent Document 6] T. Hasegawa, M. Ishikawa, K. Maruyama, N. Inadama, E. Yoshida, and H. Murayama, “Depth-of-interaction recognition using optical filters for nuclear medicine imaging,” IEEE Trans. Nucl. Sci., vol. 52, pp. 4-7, February 2005.

[Non-patent Document 7] Yoshiyuki Shirakawa, “Whole-Directional Gamma Ray Detector Using a Hybrid Scintillator,” Radioisotopes, vol. 53, pp. 445-450, 2004.

A greater distance between response positions of crystals results in better separation and enhanced discrimination ability. Accordingly, responses of crystals are ideally placed in a uniform manner on a 2D position histogram.

However, the DOI detectors proposed so far are all constructed of quadrangular prism scintillation crystals or quadrangular prism crystal elements. This limitation causes, for example, the technique (2) by which layers are made to go out of alignment, and the technique (3) that employs control of optical distribution, to generate the problem as follows. The techniques (2) and (3) are applied suitably for identification of two or four layers, as crystal regions of four layers appear on a 2D position histogram with no overlap between the crystal regions as shown in FIG. 5. However, the techniques (2) and (3) generate waste spaces in a 2D position histogram as shown in FIG. 6 if applied for identification of three layers.

Taking a limitation put on an applicable light receiving element by a relationship between the number of detectors necessary for a whole-body PET device and the like, and cost, a data processing time, and others into consideration, three layers or six layers may be optimum in some cases.

### DISCLOSURE OF INVENTION

The present invention has been made to solve the foregoing problems of the conventional techniques. A problem to be solved is to realize crystal identification without loss even with a structure such as a three-layer or six-layer structure hard to achieve by a quadrangular prism scintillation crystal.

In a DOI radiation detector, scintillation crystals are arranged in three dimensions on a light receiving surface of a light receiving element, and a response of a crystal having detected a radiation ray can be identified on the light receiving surface, thereby determining a position at which the radiation ray is detected in three dimensions. In this DOI radiation detector, the present invention solves the aforementioned problem by forming the scintillation crystals into regular triangular prisms, and by shifting response positions of the crystals for each layer.

A reflective material may be provided partially between the scintillation crystals in the same layer, so that the response positions of the respective crystals may be shifted from the center.

The position of the reflective material may be changed for each layer.

The material of the scintillation crystals may be changed for each set, so that a larger number of layers can be provided.

The present invention allows crystal identification without loss even with a structure such as a three-layer or six-layer structure hard to achieve by a quadrangular prism scintillation crystal. The present invention also enhances position resolution in radiation detection using a scintillation crystal. The detector structure is simple and easy to fabricate, and withstands mass production that is an absolute necessity for nuclear medicine devices.

### BRIEF DESCRIPTION OF DRAWINGS

FIG. 1 shows perspective views of exemplary structures of conventional DOI detectors.

FIG. 2 is a diagram showing exemplary responses of crystals appearing on a 2D position histogram in a conventional DOI detector.

FIG. 3 shows perspective views of other exemplary structures of conventional DOI detectors.

FIG. 4 is a diagram also showing still another example of a conventional DOI detector.

FIG. 5 a diagram showing an example of a four-layer DOI detector composed of the example shown in FIG. 4.

FIG. 6 is a diagram showing a problem occurring when a three-layer DOI detector is composed of a conventional quadrangular prism scintillation crystal.

FIG. 7(a) is a top view, FIG. 7(b) is a 2D position histogram, and FIG. 7(c) is a diagram showing correspondences between crystals and positions of responses relating to Comparative Example where all reflective materials are inserted, and which is given to explain the principles of the present invention.

FIG. 8(a) is, likewise, a top view, FIG. 8(b) is a 2D position histogram, and FIG. 8(c) is a diagram showing correspondences between crystals and positions of responses that show one layer of an embodiment of the present invention where part of a reflective material is removed.

FIG. 9 is a diagram showing respective layers of the embodiment of the present invention.

FIG. 10 is, likewise, a diagram showing an overall structure.

FIG. 11 is a diagram showing evaluations of crystal identification of the embodiment of the present invention.

FIG. 12 is a diagram showing a modification of the embodiment of the invention.

FIG. 13 is a diagram showing exemplary evaluations of energy characteristics of the embodiment of the invention.

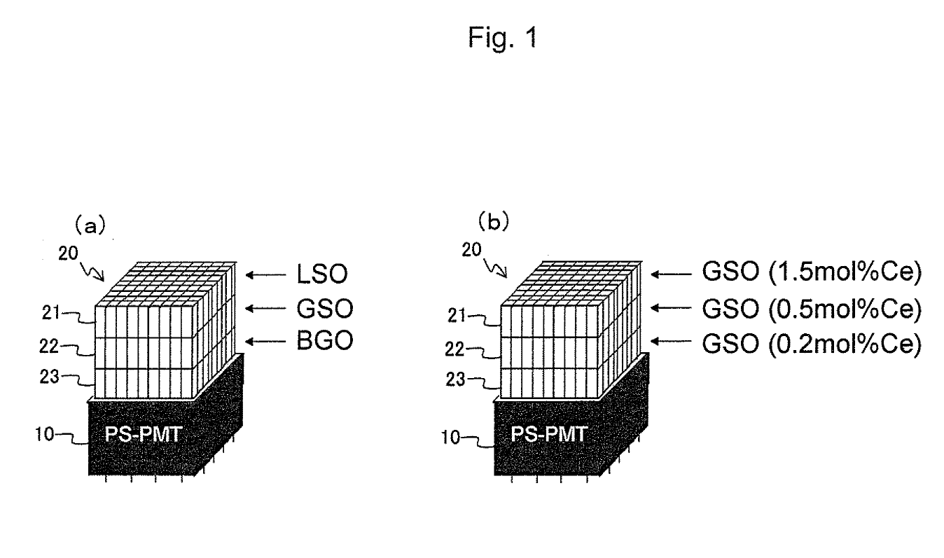

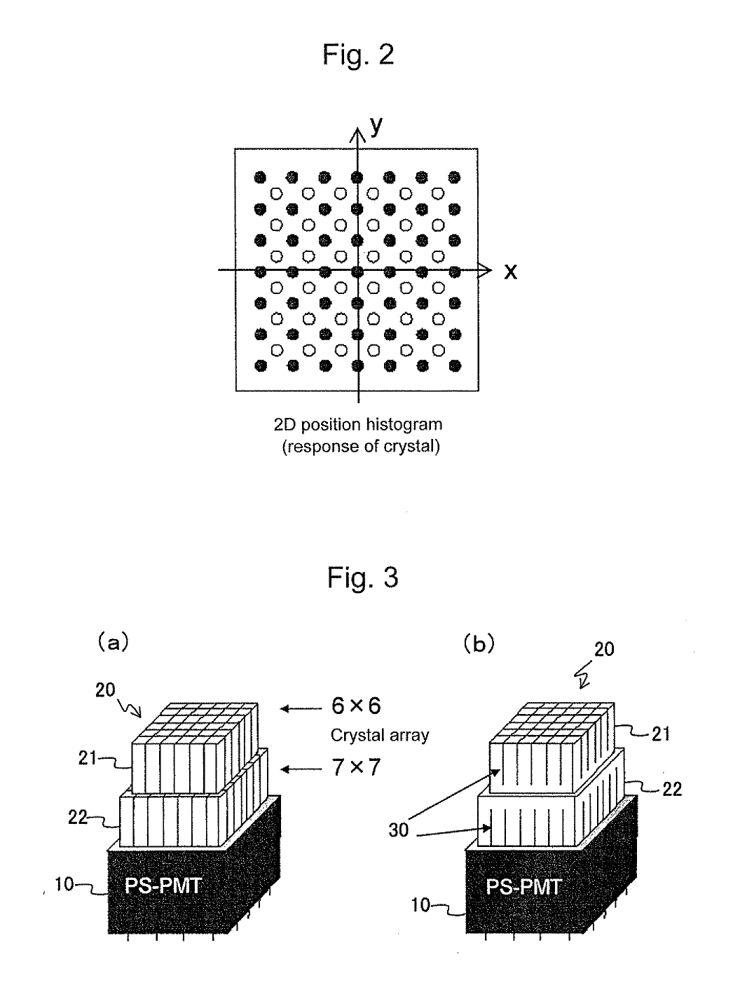

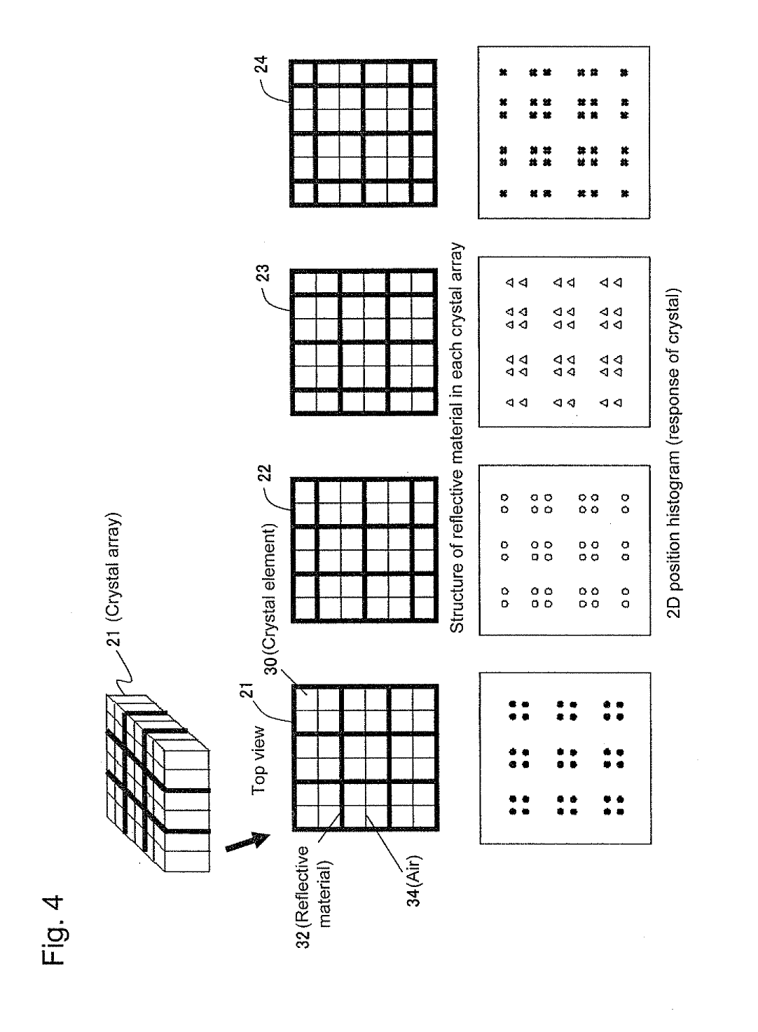

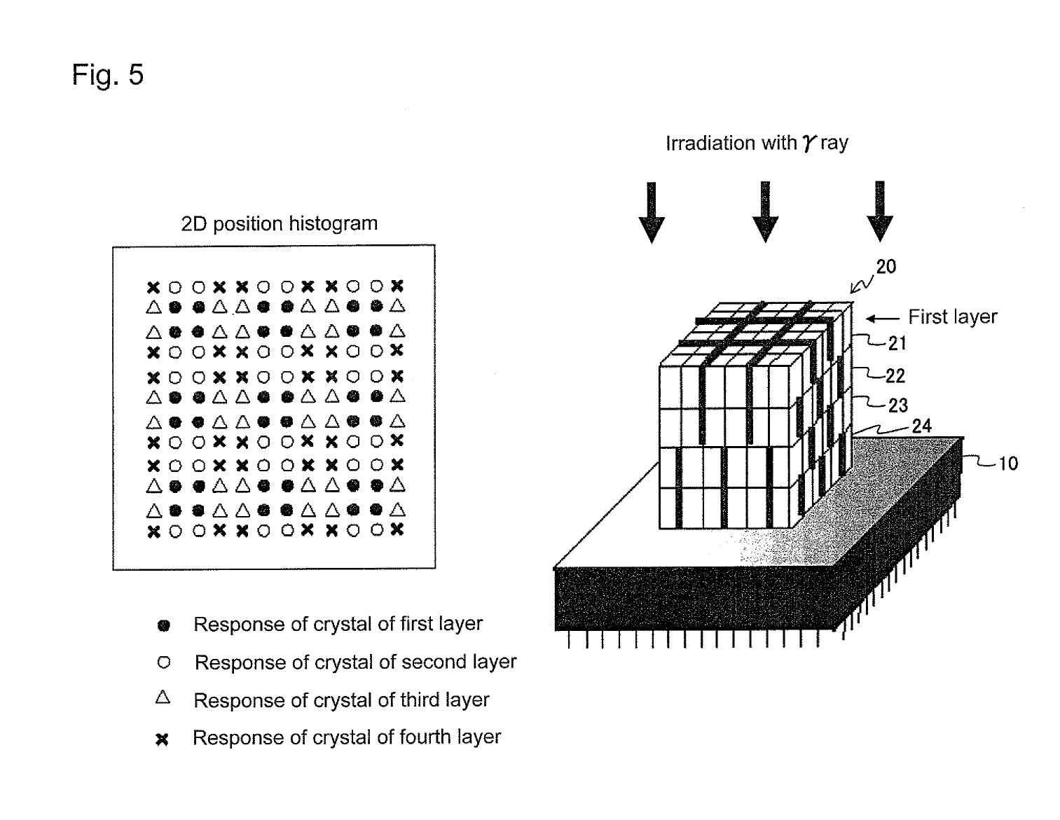

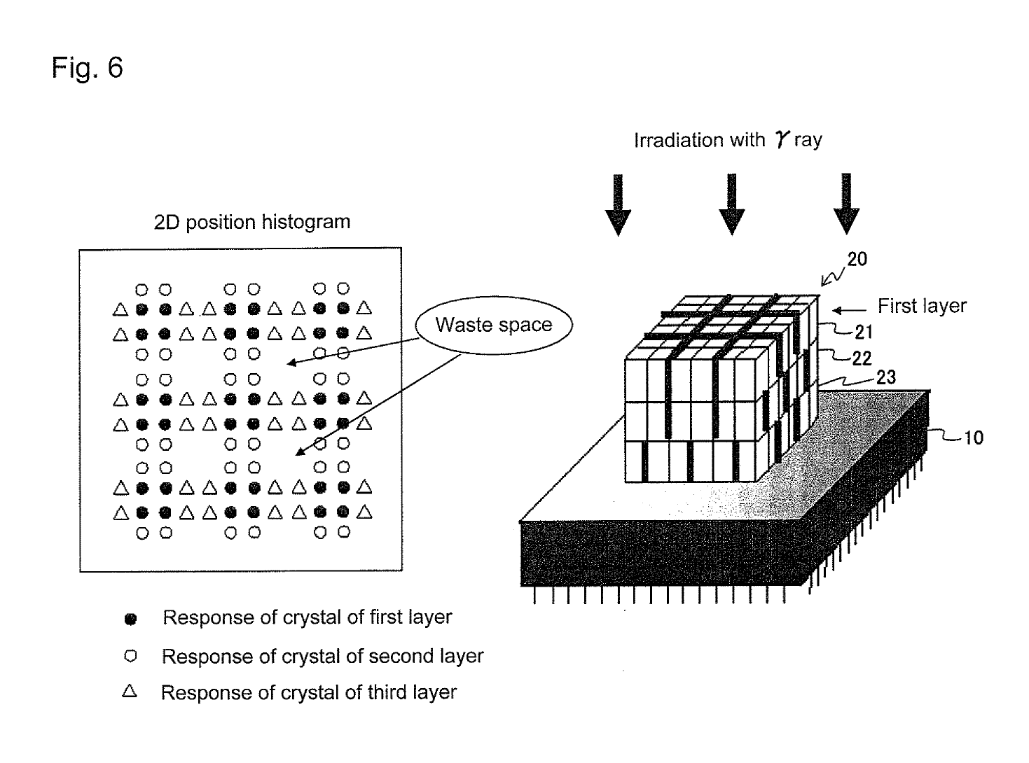

### BEST MODE(S) FOR CARRYING OUT INVENTION

An embodiment of the present invention will be described in detail with reference to the drawings.

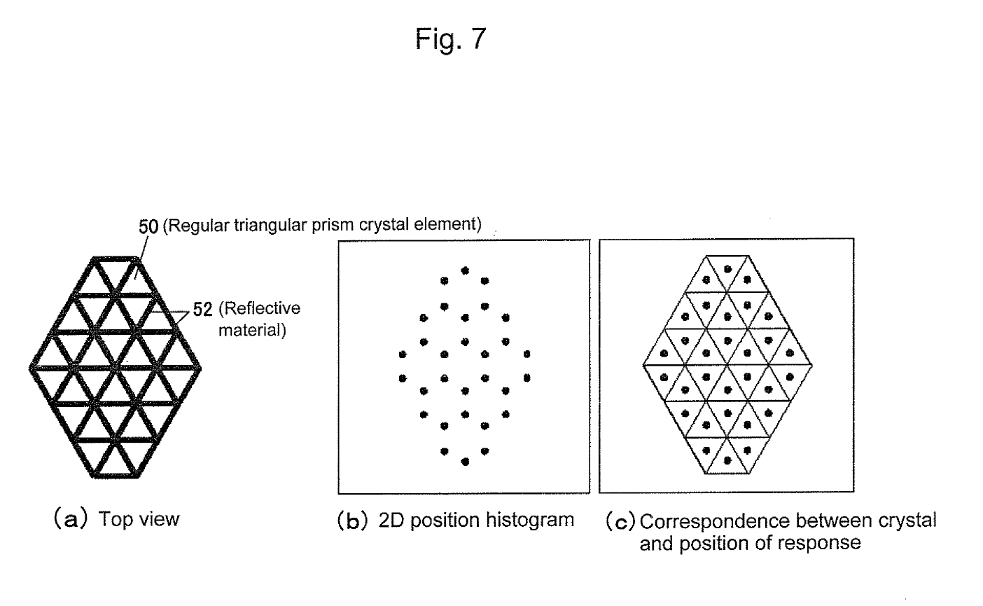

Similarly to Comparative Example shown in FIG. 7(a), if a reflective material 52 is inserted in all boundaries between densely arranged regular triangular prism crystal elements 50, a 2D position histogram as shown in FIG. 7(b) can be obtained. FIG. 7(c) shows a result obtained by making associations between the top view of crystals shown in FIG. 7(a), and the positions of responses. If the reflective material 52 is inserted in all the boundaries, responses of all the crystal elements 50 are placed at the centers of the corresponding triangles. This makes identification impossible in the case of stacked layers.

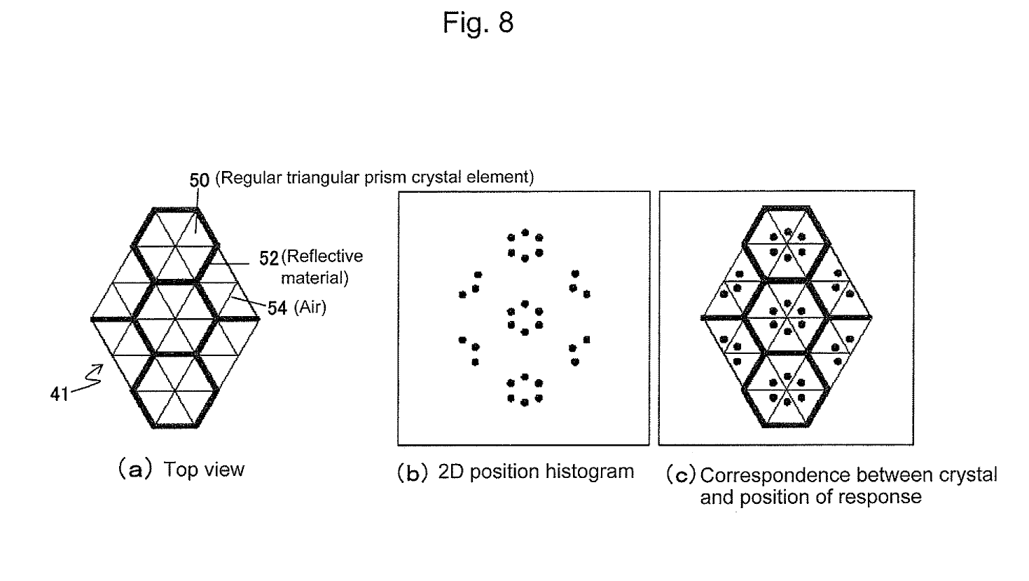

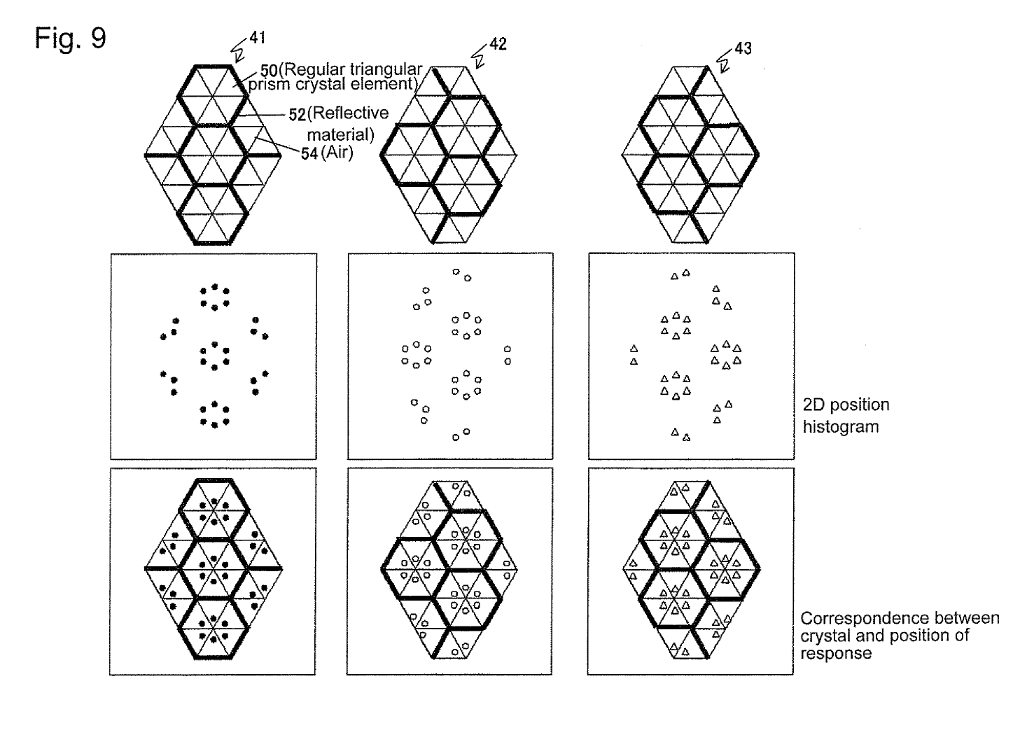

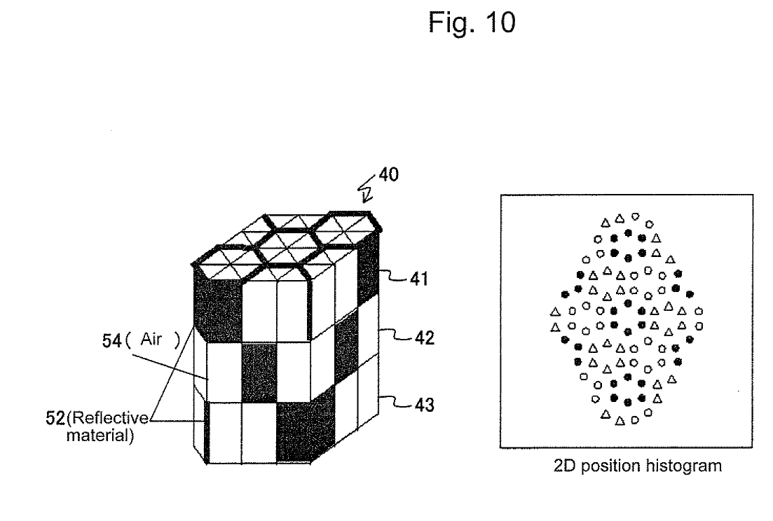

In contrast to this, in the embodiment of the present invention, the reflective material 52 is inserted for each hexagon of the crystal arrays of the densely arranged regular triangular prism crystal elements 50. In this case, scintillation light generated in some of the crystal elements 50 spreads through the other five crystal elements surrounded by the reflective material 52. Then, the scintillation light with this range of spread enters a light receiving surface of a light receiving element. As a result, responses of six crystal elements surrounding by the reflective material come close to each other on a 2D position histogram as shown in FIG. 8(b) that is a diagram showing a result of Anger calculation of the output of the light receiving element. The presence of air 54 between crystal elements puts a limitation on spread of light. Thus, response positions do not come too close to each other, and do not overlap into one accordingly. If the positions of hexagons in which the reflective material 52 is inserted are shifted between layers 41, 42 and 43 as shown in FIG. 9, response positions of crystals of the three layers appear on a 2D position histogram without overlapping each other as shown in FIG. 10. This technique, in combination with the technique (1) of waveform discrimination, realizes crystal identification of six layers. If scintillators of widely different characteristics are used in the waveform discrimination, a new consideration should be made to compensate for the difference. If scintillators of close characteristics are used, discrimination ability is degraded due to similarity in waveform. Accordingly, it is relatively difficult to select three kinds of suitable scintillators in combination. Meanwhile, use of a triangular prism crystal as in the present invention makes identification of six layers possible with two kinds of scintillators.

In this embodiment, the outer shape of a crystal block 40 is substantially rhombic in cross section, but the outer shape of a crystal block in cross section is not limited thereto. A regular hexagonal shape, or a square shape may also be applied. A reflective material is not necessarily inserted in a hexagonal position.

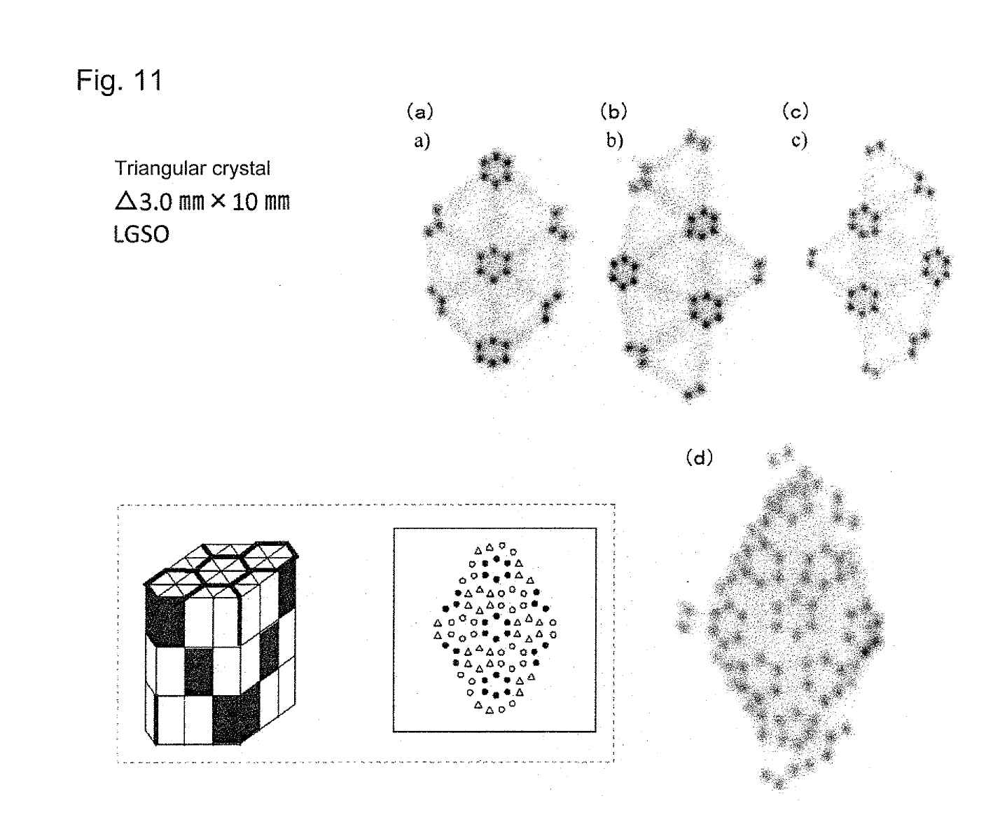

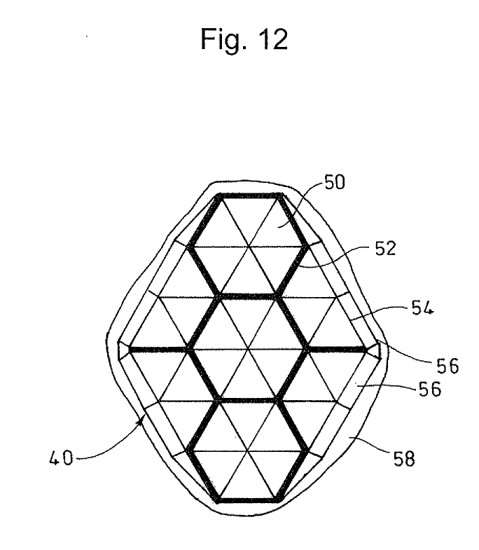

The possibility of a DOI detector using a regular triangular crystal as in the embodiment of the present invention was confirmed by experiment, and a result is shown in FIGS. 11 and 12. The crystal used was Lu₂ₓGd₂₍₁₋ₓ₎SiO₅ (LGSO) regular triangular in cross section with a side of 3 mm and a length of 10 mm. The surface of the crystal was chemically polished. A 256-channel PS-PMT was used as a light receiving element, and a film having a reflectance of 98% and a thickness of 0.067 mm was used as a reflective material. No chemical grease was used. The crystal arrays of three types with different structures of a reflective material shown in FIG. 9 were prepared, and a gamma ray of 662 keV emitted from a Cs radiation source was uniformly applied to both the side surfaces of the crystals. Then, resultant 2D position histograms were evaluated. Next, the three crystal arrays were placed in three layers as shown in FIG. 10, and a resultant three-layer DOI detector was evaluated. The resultant 2D position histograms are shown in FIG. 11. Obtained numeric values are indicated by shading. As shown in FIGS. 11(a), (b) and (c), intended responses of crystals were obtained by irradiation of each crystal array.

While crystal identification is difficult at the edges of crystals as a result of partial overlap of responses thereat, the three-layer DOI detector structure was confirmed to be capable of sufficiently identifying other crystals. The reflective material 58 wrapped around the entire structure may be a possible factor of high density at a surrounding part. In response to this, a glass layer 56 may be provided on the outer circumference of at least a portion of the air layer 54 as in a modification shown in FIG. 12.

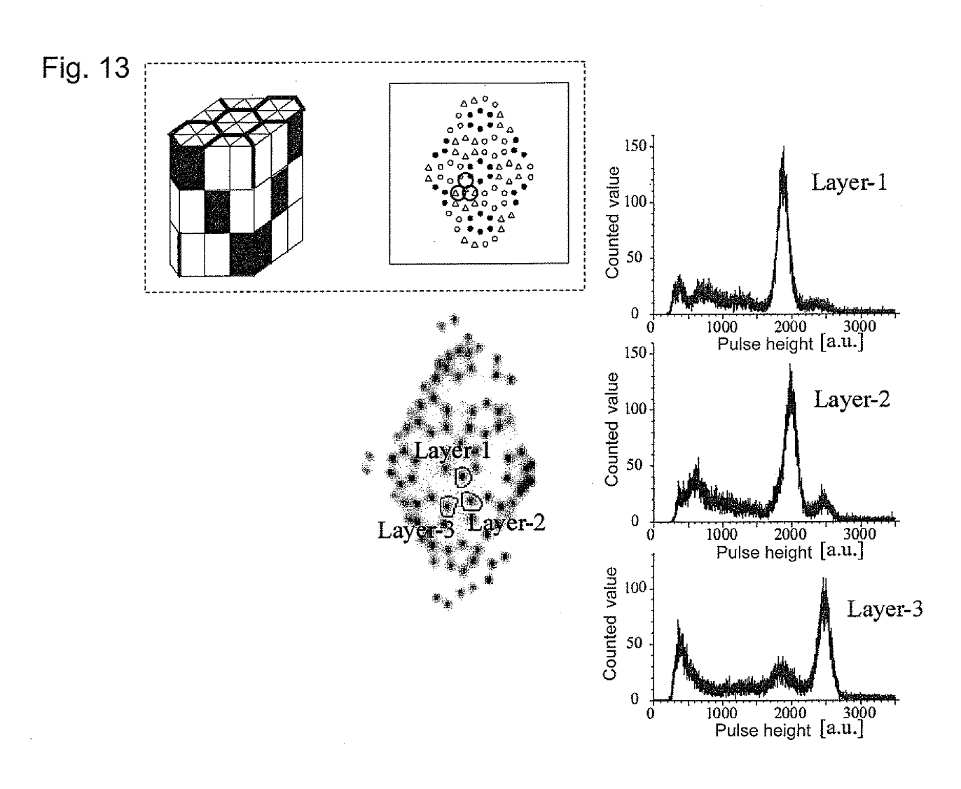

FIG. 13 shows the wave height distribution of one crystal element in each layer. The three crystal elements selected are placed in one column in the DOI structure. Good energy resolution was obtained, which was rated as 11%, 12% and 9% for the layers from the top, respectively. It was confirmed from the foregoing results that the three-layer DOI detector with a triangular prism scintillation crystal is well feasible.

### INDUSTRIAL APPLICABILITY

The DOI radiation detector according to the present invention is applicable not only for PET devices, but also for nuclear medicine imaging devices and a whole range of radiation measurement devices.

1. A DOI radiation detector in which scintillation crystals are arranged in three dimensions on a light receiving surface of a light receiving element, and a response of a crystal having detected a radiation ray can be identified on the light receiving surface, thereby determining a position at which the radiation ray is detected in three dimensions, wherein
the scintillation crystals are regular triangular prisms, and
response positions of the crystals are shifted for each layer.

2. The DOI radiation detector according to claim 1, wherein a reflective material is provided partially between the scintillation crystals in the same layer, so that the response positions of the respective crystals are shifted from the center.

3. The DOI radiation detector according to claim 2, wherein a position of the reflective material is changed for each layer.

4. The DOI radiation detector according to claim 1, wherein a material of the scintillation crystals is changed for each set, so that a larger number of layers are provided.

5. The DOI radiation detector according to claim 2, wherein a material of the scintillation crystals is changed for each set, so that a larger number of layers are provided.

6. The DOI radiation detector according to claim 3, wherein a material of the scintillation crystals is changed for each set, so that a larger number of layers are provided.
